(19) United States
(12) Patent Application Publication
(10) Pub. No.: US 2026/0168630 A1
(43) Pub. Date: Jun. 18, 2026

(54) BRACKET SYSTEMS FOR GAS CANISTERS

(71) Applicant: Ziamatic LLC, Yardley, PA (US)

(72) Inventors: Michael P. Ziaylek, Yardley, PA (US); Keith R. Creely, Levittown, PA (US); Morgan R. Sobel, Marlton, NJ (US); James Jarozynski, Collingswood, NJ (US)

(21) Appl. No.: 19/420,082

(22) Filed: Dec. 15, 2025

Related U.S. Application Data
(60) Provisional application No. 63/733,768, filed on Dec. 13, 2024.

(51) Int. Cl. F17C 13/08

(52) U.S. Cl. CPC F17C 13/084; F17C 2201/0104; F17C 2205/0157; F17C 2221/011

(57) ABSTRACT

Bracket systems for holding gas cylinders include an upper portion and a lower portion that can be mounted at different vertical locations on a mounting surface, to accommodate gas cylinders of different heights. The upper portion includes a gate configured to retain the neck of the gas cylinder. The bracket systems include straps configured to secure upper and lower portions of the gas cylinder to the respective upper and lower portions of the bracket systems. The lower portion of the bracket systems can be configured to accommodate a greater number of straps than the upper portion of the bracket systems.

### CROSS-REFERENCE TO RELATED APPLICATIONS

This application claims the benefit under 35 U.S.C. § 119(e) of U.S. Application No. 63/733,768, filed Dec. 13, 2024, the contents of which are incorporated by reference herein in their entirety.

### BACKGROUND

Gas cylinders, such as portable oxygen tanks, often are stowed in an upright orientation. In applications where gas cylinders are being carried on a moving vehicle, the gas cylinders need to be stowed in a manner that secures the gas cylinders in position. For example, fire engines typically carry portable oxygen tanks for use by firefighters in firefighting and rescue operations. Because the portable oxygen tanks may need to be retrieved quickly, and under exigent circumstances, the oxygen tanks need to be stowed in a manner that adequately restrains the tanks during transport while facilitating quick and easy retrieval under adverse conditions that can include inclement weather, low visibility, restricted access, etc. Also, gas cylinders such as oxygen tanks are provided in a variety of sizes, which can make secure but readily accessible stowage challenging.

### SUMMARY

In one aspect of the disclosed technology, a bracket system for holding a gas cylinder includes an upper portion having an upper backplate with a mounting portion configured to be fixed to a mounting surface, and an upper strap extending though the upper backplate and configured to secure the gas cylinder to the upper portion. The bracket system also includes a lower portion having a lower backplate with a mounting portion configured to be fixed to the mounting surface, and a lower strap extending though the lower backplate and configured to secure the gas cylinder to the lower portion. The bracket system further includes a retaining gate mounted on the upper portion and configured to engage a neck of the gas cylinder to retain the gas cylinder on the upper portion.

In another aspect of the disclosed technology, the upper portion and the lower portion are physically separate.

In another aspect of the disclosed technology, the upper portion and the lower portion are configured to be spaced apart on the mounting surface.

In another aspect of the disclosed technology, a position of the upper portion on the mounting surface in relation to a position of the lower portion on the mounting surface is variable.

In another aspect of the disclosed technology, the upper portion further includes a top retainer fixed to the mounting portion of the upper backplate and configured to receive at least a portion of the neck of the gas cylinder, and the retaining gate is mounted on the top retainer.

In another aspect of the disclosed technology, the retaining gate includes a gate member configured to move between a closed position at which the gate member can engage the neck of the gas cylinder and retain the at least a portion of the neck of the gas cylinder in the top retainer, and an open position.

In another aspect of the disclosed technology, the retaining gate is configured to lock the gate member in the closed position.

In another aspect of the disclosed technology, the gate member is coupled to and configured to rotate in relation to the top retainer.

In another aspect of the disclosed technology, the gate member is configured to rotate in a horizontal plane in relation to the top retainer.

In another aspect of the disclosed technology, the gate member is coupled for rotation to the top retainer by a first bolt extending through a first end portion of the gate member.

In another aspect of the disclosed technology, a second end portion of the gate member includes a J-shaped portion, and the retaining gate further includes a second bolt configured to extend through the J-shaped portion.

In another aspect of the disclosed technology, the second bolt is configured to engage a weld nut fixed to an underside of the top retainer when the gate member is in the closed position.

In another aspect of the disclosed technology, the retaining gate further includes a flange nut positioned on the second bolt between upper and lower sections of the J-shaped portion and configured to securely engage the lower section of the J-shaped portion when the gate member is in the closed position and the second bolt has securely engaged the weld nut.

In another aspect of the disclosed technology, the flange nut, the weld nut, and the second bolt are configured to clamp the gate member to the top retainer when the flange nut securely engages the lower section of the J-shaped portion of the gate member.

In another aspect of the disclosed technology, the lower portion further includes a bottom retainer fixed to the mounting portion of the lower backplate and configured to support a bottom surface of the gas cylinder.

In another aspect of the disclosed technology, the upper portion includes not more than one upper strap, and the lower portion includes at least two lower straps.

In another aspect of the disclosed technology, the upper portion includes one or more upper straps, the lower portion includes two or more lower straps, and the total number of lower straps exceeds the total number of upper straps.

In another aspect of the disclosed technology, the system further includes a first fastener configured to removably connect ends of the upper strap, and a second fastener configured to removably connect ends of the lower strap. The first and second fasteners each include a J-hook connected to first ends of the respective upper and lower straps, and a buckle connected to second ends of the respective upper and lower straps. The J-hooks are configured to removably engage the buckles.

In another aspect of the disclosed technology, the system further includes a plurality of pads each fixed to an inwardly-facing surface of a respective one of the J-hooks.

In another aspect of the disclosed technology, a method of mounting a gas cylinder includes providing the above bracket system, mounting the upper backplate on the mounting surface at a first vertical position on the mounting surface, mounting the lower backplate on the mounting surface at a second vertical position on the mounting surface, and selecting the first and second locations based on a vertical height of the gas cylinder.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a top-front perspective view of a bracket system for a gas cylinder, depicting a gate of a retaining gate of the system in a closed position and depicting straps of the system in a buckled state;

FIG. 2 is a magnified view of the bracket system shown in FIG. 1, depicting the gate in the closed position;

FIG. 3 is a magnified view of the bracket system shown in FIGS. 1 and 2, depicting the gate in a partially closed position; and

FIG. 4 is a magnified view of the bracket system shown in FIGS. 1-3, depicting one of the straps in an unbuckled state.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

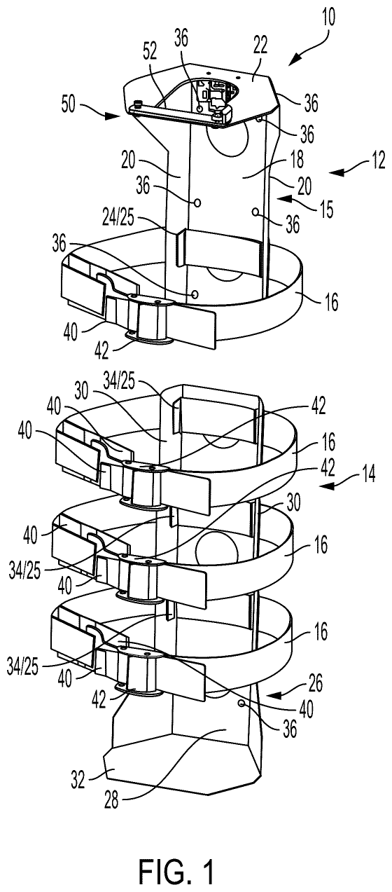

A bracket system 10 is provided for the stowage and retrieval of a gas cylinder (not shown). The gas cylinder can be used, for example, to hold pressurized oxygen. Referring to FIG. 1, the bracket system 10 includes a first, or upper portion 12 and a second, or lower portion 14. The upper and lower portions 12, 14 are configured to be mounted on a mounting surface, and can be spaced apart by a vertical distance selected to accommodate the height of the specific type of gas cylinder to be stowed on the bracket system 10. For example, the bracket system 10 can be configured to accommodate M-size to J-size oxygen cylinders; and gas cylinders having heights between about 33 inches and about 55 inches, and diameters of about 8.0 inches to about 10 inches. Alternative embodiments of the bracket system 10 can be sized to accommodate gas cylinders having dimensions lying outside of the above-noted ranges.

The bracket system 10 can be installed, for example, on a wall of a building or other static structure. In other applications, the bracket system 10 can be installed on a vehicle, such as an ambulance, fire engine, or other emergency vehicle. In other applications, the bracket system 10 can be installed on a motorized or non-motorized device that can lift and retract the gas cylinder while it is installed on the bracket system 10. In some applications, the upper portion 12 and the lower portion 14 can be mounted on a structure that permits the vertical position of one or both of the upper and lower portions 12, 14 to be varied in relation to the other of the upper and lower portions 12, 14, to tailor the spacing between the upper and lower portions 12, 14 to accommodate a gas cylinder of a particular height.

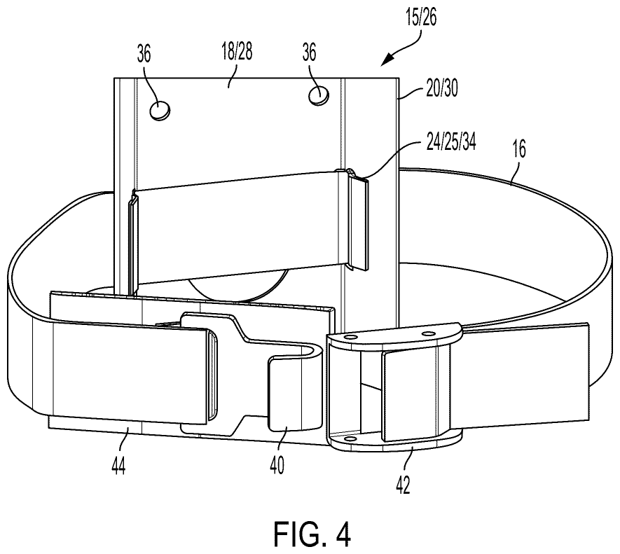

Referring to FIGS. 1 and 4, the upper portion 12 includes a backplate 15, and a strap 16 configured to restrain the gas cylinder against the backplate 15. The backplate 15 has a flat mounting portion 18, and two flanges 20 fixed to the opposite sides of the mounting portion 18. The backplate 15 also includes a top retainer 22 fixed to upper edges of the mounting portion 18 and the flanges 20.

Each flange 20 has an opening 24 formed therein and configured to receive the strap 16. An edge guard 25 is positioned within each opening 24. The strap 16 extends through the edge guards 25. The edge guards 25 isolate the strap 16 from the surfaces of the flanges 20 and the mounting portion 18 that define so openings 24, to help prevent chafing or cutting of the strap 16, for example, when the bracket system 10 and the gas cylinder are subjected to large inertial loads than may be encountered during sudden deceleration of a vehicle on which the bracket system 10 is installed.

The lower portion 14 includes a backplate 26, and three straps 16 configured to restrain the gas cylinder against the backplate 15. The backplate 26 has a flat mounting portion 28, and two flanges 30 fixed to the opposite sides of the mounting portion 28. The backplate 26 also includes a foot, or bottom retainer 32 fixed to lower edges of the mounting portion 28 and the flanges 30. The bottom retainer 32 is configured so that a portion of the lower edge of the gas cylinder can rest on the bottom retainer 32, with the bottom retainer 32 supporting the gas cylinder.

Each flange 30 has an opening 34 formed therein and configured to receive a respective strap 16. One of the edge guards 25 is positioned within each opening 34. The straps 16 associated with the lower portion 14 extend through the edge guards 25. As discussed above in relation to the upper portion 14, the edge guards 25 isolate the straps 16 from the surfaces of the flanges 30 and the mounting portion 28 that define the openings 44, to help prevent chafing or cutting of the straps 16.

The backplate 15 of the upper portion 12 and the backplate 26 of the lower portion 14 each have a plurality of holes 36 formed therein. The holes 36 accommodate fasteners, such as bolts, that secure the upper and lower portions 12, 14 to the mounting surface.

The holes 36 are positioned proximate the side edges of the backplates 15, 26, with each hole 36 being positioned at the same vertical position as another one of the holes 36. The holes 36 within each pair of holes 36 located at the same vertical position are spaced apart by a distance sufficient to avoid contact between the gas cylinder and the fasteners accommodated within the holes. For example, the bracket system 10 can be configured to accommodate gas cylinders having diameters of up to 10 inches. Thus, the spacing between the holes 36 within each pair of holes 36 can be about 10 inches or more.

The material from which the straps 16 are formed, and the width of the straps 16 can be chosen to limit stretching of the straps 16 while providing maximum load retention. For example, each strap 16 can be formed from nylon, and can have a width of about two inches. The straps 16 can be formed from other materials, and can have other widths in alternative embodiments.

Each of the straps 16 includes a fastening device configured to secure the ends of each strap 16 together. The fastening device can be, for example, a steel J-hook 40 and a buckle 42. Each J-hook 40 can be permanently secured to a first end of an associated strap 16 by, for example, a loop sewn in the strap 16 and extending through a slot in the J-hook 40, as can be seen in FIG. 4. The J-hooks 40 can be configured so as not to fail before the straps 16 under extreme loads. In some embodiments, the J-hooks 40 can be rated for a 2,000 lb-force working load. The J-hooks 40 can be rated for working loads below and above this value in alternative embodiments.

A protective pad 44 can be fixed to the rearward-facing side of each J-hook 40, to help prevent scuffing and other damage to the gas cylinder caused by contact with the J-hook 40. The pad 44 can be formed from a relatively soft, non-abrasive material such as nylon.

A second end of the strap 16 is looped through the associated buckle 42, so that the effective length of the strap 16 can be adjusted to accommodate the specific type of gas cylinder being stowed on the bracket system 10. The use of the J-hook 40 and buckle 42 permits the strap 16 to be fastened around and unfastened from the gas cylinder in a quick and intuitive manner, without a need to disconnect the strap 16 from the buckle 42. This feature thus can facilitate the retrieval of the gas cylinder from the bracket system 10, and re-installation of the gas-cylinder 11 on the bracket system 10 in an expeditious manner, in comparison to a conventional one-piece buckle through which an end of the strap 16 must be threaded and unthreaded in order to join and separate the opposing ends of the strap 16. The use of the J-hook 40 and the buckle 42 can be particularly advantageous, for example, in applications where a first responder may need to retrieve and re-install the gas cylinder under exigent circumstances, under low-light and adverse weather conditions, or in a confined area or an area that is not readily accessible on an emergency vehicle or other location.

Also, the use of the J-hook 40 and buckle 42 can reduce the potential for the strap 16 to be re-threaded into the buckle 42 in the wrong direction which, should it occur, could reduce the retention capability of the strap 16.

Referring to FIGS. 1-3, the bracket system 10 also includes an upper retaining member, or retaining gate 50. The retaining gate 50 is configured to restrain the upper end of the gas cylinder. The retaining gate 50 includes an elongated member in the form of a gate member 52. The gate member 52 can be formed from a relatively strong and rigid material such as steel or a steel alloy.

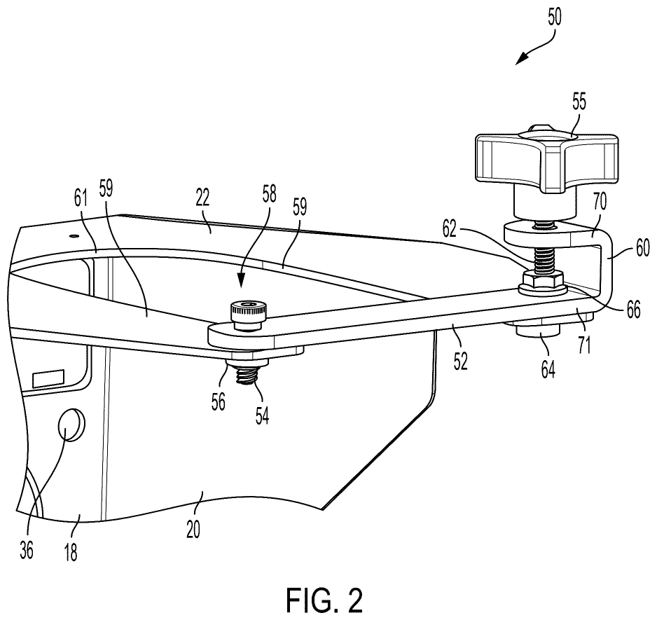

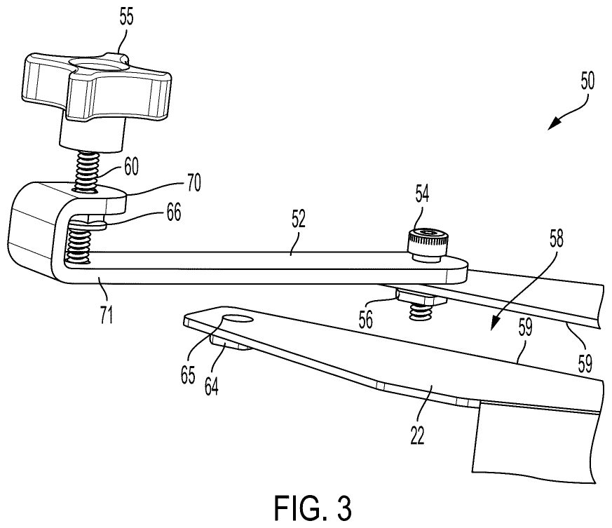

The gate member 52 is connected to the top retainer 22 of the backplate 15 of the upper portion 12 by a fastener, such as a shoulder bolt 54. The shoulder bolt 54 extends though a though hole formed in a first end portion of the gate member 52, and a first through hole formed in the top retainer 22. The shoulder bolt 54 is retained in the through holes by a suitable device such as a weld nut 56 that is fixed to an underside of the top retainer 22 and aligned with the first through hole in the top retainer 22 to threadably engage the shoulder bolt 54. The shoulder bolt 54 retains the gate member 52 on the top retainer 22 at all times, and facilitates rotation of the gate member 52 in relation to the top retainer 22 between a closed position shown in FIGS. 1 and 2, and an open position shown (not shown). FIG. 3 depicts the gate member 52 in a position between its closed and open positions.

The shoulder bolt 54 can be formed, for example, from steel or a steel alloy. A knob 55 can be positioned on the upper end of the shoulder bolt 54, to enable the user to rotate the shoulder bolt 54 by hand.

The top retainer 22 defines an open area or cutout 58. The cutout 58 has substantially straight sides 59, and a curvilinear end portion 61. The cutout 58 is sized and shaped to receive an upper portion, or neck of the gas cylinder. As can be seen in FIGS. 1-3, the first through hole in the top retainer 22 that accommodates the shoulder bolt 54 is located proximate a first of the sides 59 of the cutout 58 and proximate the open end of the cutout 58. Thus, the gate member 52 is rotatably connected to the top retainer 22 proximate a first side 59 of the cutout 58 and proximate the open end of the cutout 58, so that the gate member 52 spans the open end of the cutout 58 when the gate member 52 is in its closed position as shown in FIG. 2. The gate member 52 thus restrains the neck of the gas cylinder when in the closed position by preventing the neck from exiting the cutout 58, helping to retain the gas cylinder on the bracket system 10.

The gate member 52 has a J-bend, or J-shaped portion 60 that forms a second end of the gate member 52. The J-shaped portion 60 has two through holes formed in respective upper and lower sections 70, 71 thereof and positioned to vertically align with each other. The gate member 52 can be retained in its closed position by a fastener, such as a bolt 62, that extends through the J-shaped portion 62, via the through holes therein. The bolt 62 can be formed, for example, from steel or a steel alloy.

The top retainer 22 has a second through hole 65 formed therein, proximate a second of the sides 59 of the cutout 58 and proximate the open end of the cutout 58. The second through hole 65 is visible in FIG. 3. The through holes in the J-shaped portion 60 are configured to align with the second through hole 65 when the gate member 52 is in its closed position.

A weld nut 64 is fixed to the underside of the top retainer 22. The weld nut 64 is aligned with the second through hole 65, so that the weld nut 64 can threadably engage the bolt 62 when the gate member 52 is in its closed position and the bolt 62 is inserted through the second through hole 65. The engagement of the bolt 62 with the J-shaped portion 60 of the gate member 52, the top retainer 22, and the weld nut 64 restrains the second end of the gate member 52, i.e., the J-shaped portion 60, in relation to the top retainer 22, thereby locking the gate member 52 in its closed position.

A flange nut 66 is positioned on the shaft of the bolt 62. The flange nut 66 is positioned on the shaft of the bolt 62 so as to frictionally engage the upwardly-facing surface on the lower second 71 of the J-shaped portion 60 of the gate member 52 when the bolt 62 has fully engaged the weld nut 64 as shown in FIG. 2. The flange nut 66 is positioned on the bolt 62 between the upper and lower sections 70, 71 of the J-shaped portion 60, and can freely float, along with the bolt 62, between the upper and lower sections 70, 71 when the bolt 62 is not secured to the weld nut 64. The flange nut 66, the weld nut 64, and the bolt 62 clamp the J-shaped portion 60 of the gate member 52 onto the top retainer 22 to secure the gate member 52 to the top retainer 22. The flange nut 66, after having its vertical position on the bolt 62 adjusted so that the flange nut 66 engages the lower section 71 of the J-shaped portion 60 when the bolt 62 has fully engaged the weld nut 64 (as shown in FIG. 2), is secured to the bolt 62 using, for example, a suitable thread-locking fluid. The flange nut 66 thus rotates, and travels upwardly and downwardly with the bolt 62. Once the flange nut 66 has been tightened onto the J-shaped portion 60, friction between the contacting surfaces of the J-shaped portion 60 and the flange nut 66 inhibits the bolt 62 from backing out of the weld nut 64, helping to ensure that the gate member 52 remains in the closed position until moved from the closed position by the user.

The positioning of the weld nuts 56, 64 on opposite sides of the cutout 58 in the top retainer 22 allows the position of the gate member 52 to be reversed from that shown in FIGS. 1-3.

The gate member 52 can be rotated to its open position when the gas cylinder is to be installed on the bracket system 10, allowing the neck of the gas cylinder to be positioned within the cutout 58 in the top retainer 22. Once the neck of the gas cylinder has been positioned within the cutout 58, the gate member 52 can be rotated to its closed position shown in FIGS. 1 and 2, while the user pulls upwardly on the knob 55 so as to position the bolt 62 in a relatively high position in relation to the J-shaped portion 60 of the gate member 52. As can be seen in FIG. 3, the vertical spacing between the upper and lower sections 70, 71 of the J-shaped portion 60 is sufficient to permit the bolt 62 to float to a high-enough position so as not to interfere with the ability of the J-shaped portion 60 to move over the top retainer 22 as the gate member 52 approaches its closed position.

Once the gate member 52 has been rotated so that the bolt 62 is aligned with the second through hole 65 in the top retainer 22 (which occurs as the gate member 52 reaches its closed position), the user can allow the end of the bolt 62 to drop into the second through hole 65 and onto the weld nut 64. The positioning of the bolt 62 in the through holes formed in the upper and lower sections 70, 71 of the J-shaped portion 60 can help maintain the bolt 62 is the proper orientation to engage the weld nut 64. The user then can rotate the knob 55, and the attached bolt 62, to cause the end of the bolt 62 to threadably engage the weld nut 64. The continued rotation of the knob 55 eventually causes the flange nut 66 on the shaft of the bolt 62 to contact the upwardly-facing surface on the lower section 71 of the J-shaped portion 60, as shown in FIG. 2. At this point, further rotation of the knob 55 and the bolt 62 will increase the frictional force between the flange nut 66 and the contacting surface on the lower section 71 of the J-shaped portion 60, securing the flange nut 66, and the attached bolt 62, in place in relation to the top retainer 22. As discussed above, the engagement of the bolt 62 with the J-shaped portion 60 of the gate member 52, the top retainer 22, and the weld nut 64 restrains the second end of the gate member 52, i.e., the J-shaped portion 60, in relation to the top retainer 22, thereby locking the gate member 52 in its closed position.

When the user desires to remove the gas cylinder from the bracket system 10, the user can rotate the knob 55 so as to cause the end of the bolt 62 to disengage from the weld nut 64. The user then can lift the knob 55, and the attached bolt 62, to lift the end of the bolt 62 out of the second through hole 65 in the top retainer 22. At this point, the gate member 52 can be rotated to its open position so that the neck of the gas cylinder can be removed from the cutout 58. Also, the flange nut 66 prevents the bolt 62 from backing out of the though holes in the J-shaped portion 60 of the gate member 52 when the bolt 62 is disengaged from the weld nut 64. Thus, there are no removable parts in the retaining gate 50, reducing the potential for parts to be lost when the gas cylinder is being installed on and removed from the bracket system 10.

The retaining gate 50 can be configured to withstand a load of about 7,400 pounds. The retaining gate 50 can be configured to withstand loads greater than, and less than this value in alternative embodiments.

In alternative embodiments, the gate member 52 can be configured to rotate between a horizontal and a vertical orientation when moving between its closed and open positions. In other alternative embodiments, the gate member 52 can be configured to slide or otherwise move linearly between its closed and open positions.

As noted above and as depicted in FIG. 1, the lower portion 14 of the bracket system 10 includes three of the straps 16, and the upper portion 14 includes one strap 16. Thus, the straps 16 are concentrated on the lower portion of the gas cylinder. This can help to reduce the potential for the lowermost strap 16 or straps 16 to stretch excessively or fail when the gas cylinder is subjected to extreme loads, such as the loads that can occur during a motor-vehicle accident. Because the upper end of the gas cylinder is retained primarily by the relatively rigid retaining gate 50, the loading on the straps 16 could increase progressively in a direction toward the bottom of the gas cylinder if the straps 16 were equally spaced. This in turn could lead to excessive stretching or failure of the lower straps 16 that would allow the bottom of the gas cylinder to slip off the bottom retainer 32 of the backplate 26 of the lower portion 14, resulting in the gas cylinder being partially or fully unrestrained. Thus, concentrating the straps 16 toward the lower end of the gas cylinder can help reduce the maximum stresses to which the lowermost straps 16 are subjected, thereby reducing the potential for the gas cylinder to partially or fully separate from the bracket system 10 when subjected to high inertial or other types of loads.

In alternative embodiments, the lower portion 14 of the bracket system 10 can include less, or more than three of the straps 16; and the upper portion 11 can include more than one of the straps 16.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above-described embodiments. Rather, the scope of the present solution should be defined in accordance with the following claims and their equivalents.

What is claimed is:

1. A bracket system for holding a gas cylinder, comprising:
an upper portion including:
an upper backplate having a mounting portion configured to be fixed to a mounting surface, and
an upper strap extending though the upper backplate and configured to secure the gas cylinder to the upper portion;
a lower portion including:
a lower backplate having a mounting portion configured to be fixed to the mounting surface, and
a lower strap extending though the lower backplate and configured to secure the gas cylinder to the lower portion; and
a retaining gate mounted on the upper portion and configured to engage a neck of the gas cylinder to retain the gas cylinder on the upper portion.

2. The system of claim 1, wherein the upper portion and the lower portion are physically separate.

3. The system of claim 1, wherein the upper portion and the lower portion are configured to be spaced apart on the mounting surface.

4. The system of claim 1, wherein a position of the upper portion on the mounting surface in relation to a position of the lower portion on the mounting surface is variable.

5. The system of claim 1, wherein:
the upper portion further includes a top retainer fixed to the mounting portion of the upper backplate and configured to receive at least a portion of the neck of the gas cylinder; and
the retaining gate is mounted on the top retainer.

6. The system of claim 5, wherein the retaining gate includes a gate member configured to move between: a closed position at which the gate member can engage the neck of the gas cylinder and retain the at least a portion of the neck of the gas cylinder in the top retainer; and an open position.

7. The system of claim 6, wherein the retaining gate is configured to lock the gate member in the closed position.

8. The system of claim 6, wherein the gate member is coupled to and configured to rotate in relation to the top retainer.

9. The system of claim 8, wherein the gate member is configured to rotate in a horizontal plane in relation to the top retainer.

10. The system of claim 8, wherein the gate member is coupled for rotation to the top retainer by a first bolt extending through a first end portion of the gate member.

11. The system of claim 10, wherein:
a second end portion of the gate member includes a J-shaped portion; and
the retaining gate further includes a second bolt configured to extend through the J-shaped portion.

12. The system of claim 11, wherein the second bolt is configured to engage a weld nut fixed to an underside of the top retainer when the gate member is in the closed position.

13. The system of claim 12, wherein the retaining gate further includes a flange nut positioned on the second bolt between upper and lower sections of the J-shaped portion and configured to securely engage the lower section of the J-shaped portion when the gate member is in the closed position and the second bolt has securely engaged the weld nut.

14. The system of claim 13, wherein the flange nut, the weld nut, and the second bolt are configured to clamp the gate member to the top retainer when the flange nut securely engages the lower section of the J-shaped portion of the gate member.

15. The system of claim 1, wherein the lower portion further includes a bottom retainer fixed to the mounting portion of the lower backplate and configured to support a bottom surface of the gas cylinder.

16. The system of claim 1, wherein:
the upper portion includes not more than one upper strap; and
the lower portion includes at least two lower straps.

17. The system of claim 1, wherein:
the upper portion includes one or more upper straps; and
the lower portion includes two or more lower straps; and
the total number of lower straps exceeds the total number of upper straps.

18. The system of claim 1, further comprising:
a first fastener configured to removably connect ends of the upper strap; and
a second fastener configured to removably connect ends of the lower strap; wherein:
the first and second fasteners each include a J-hook connected to first ends of the respective upper and lower straps, and a buckle connected to second ends of the respective upper and lower straps, and
the J-hooks are configured to removably engage the buckles.

19. The system of claim 18, further including a plurality of pads each fixed to an inwardly facing surface of a respective one of the J-hooks.

20. A method of mounting a gas cylinder, comprising:
providing the bracket system of claim 1;
mounting the upper backplate on the mounting surface at a first vertical position on the mounting surface;
mounting the lower backplate on the mounting surface at a second vertical position on the mounting surface; and
selecting the first and second locations based on a vertical height of the gas cylinder.
